(19) United States
(12) Patent Application Publication
(10) Pub. No.: US 2002/0135523 A1
(43) Pub. Date: Sep. 26, 2002

(54) Loop antenna radiation and reference loops

(76) Inventors: Osbaldo Jose Romero, San Francisco, CA (US); Walter John Keller III, Redwood City, CA (US); David Amundson Howard, Newark, CA (US)

Correspondence Address: David E. Lovejoy, Fliesler, Dubb, Meyer & Lovejoy, Suite 400, Four Embarcadero Center, San Francisco, CA, 94111-4156, US

(21) Appl. No.: 09/815,928

(22) Filed: Mar. 23, 2001

(51) Int. Cl. H01Q 11/12; H01Q 7/00

(52) U.S. Cl. 343/741; 343/866

(57) ABSTRACT

A loop antenna formed of an radiation loop and a reference loop. The reference loop is generally the same size, shape and electrical length as the radiation loop and is located in the near field of and in close proximity to the radiation loop. In communication devices having conductive surfaces, components, shielding and other conductive elements in close proximity to the radiation loop, the coupling to the radiation loop that tends to de-tune or otherwise interfere with the operation of the radiation loop is reduced by the reference loop.

### CROSS-REFERENCED APPLICATION

The present application is related to the application entitled ARRAYED-SEGMENT LOOP ANTENNA, invented by David Amundson Howard, having SC/Ser. No. 09/738,906 filed Dec. 14, 2000.

### BACKGROUND OF THE INVENTION

The present invention relates to the field of communication devices that communicate using radiation of electromagnetic energy through antennas and particularly relates to portable phones, pagers, computers and other wireless devices.

For personal communication devices, an antenna is frequently located in proximity to conductive surfaces, components, shielding and other potentially interfering elements. The near proximity of antennas to such elements can adversely affect antenna performance.

Antennas are elements having the primary function of transferring energy to or from a communication device through radiation. Energy is transferred from the communication device into space or is received from space into the communication device. A transmitting antenna forms a transition between guided waves contained within a communication device and space waves traveling in space external to the communication device. A receiving antenna forms a transition between space waves traveling external to a communication device and guided waves contained within the communication device. Often the same antenna operates both to receive and transmit radiation energy.

J. D. Kraus “Electromagnetics” , 4th ed., McGraw-Hill, New York 1991, Chapter 15 Antennas and Radiation indicates that antennas are designed to radiate (or receive) energy. Antennas act as the transition between space and circuitry. They convert photons to electrons or vice versa. Regardless of antenna type, all involve the same basic principal that radiation is produced by accelerated (or decelerated) charge. The basic equation of radiation may be expressed as follows:

IL=Qν(Am/s)

where:

I=time changing current (A/s)

L=length of current element (m)

Q=charge (C)

ν=time-change of velocity which equals the acceleration of the charge (m/s)

The radiation is perpendicular to the direction of acceleration and the radiated power is proportional to the square of IL or Qν.

A radiated wave from or to an antenna is distributed in space in many spatial directions. The time it takes for the spatial wave to travel over a distance r into space between an antenna point, Pₐ, at the antenna and a space point, Pₛ, at a distance r from the antenna point is r/c seconds where r=distance (meters) and c=free space velocity of light (=3×10⁸ meters/sec). The quantity r/c is the propagation time for the radiation wave between the antenna point Pₐ and the space point Pₛ.

An analysis of the radiation at a point Pₛ at a time t, at a distance r caused by an electrical current I in any infinitesimally short segment at point Pₐ of an antenna is a function of the electrical current that occurred at an earlier time [t−r/c] in that short antenna segment. The time [t−r/c] is a retardation time that accounts for the time it takes to propagate a wave from the antenna point Pₐ at the antenna segment over the distance r to the space point Pₛ.

Antennas are typically analyzed as a connection of infinitesimally short radiating antenna segments and the accumulated effect of radiation from the antenna as a whole is analyzed by accumulating the radiation effects of each antenna segment. The radiation at different distances from each antenna segment, such as at any space point Pₛ, is determined by accumulating the effects from each antenna segment of the antenna at the space point Pₛ. The analysis at each space point Pₛ is mathematically complex because the parameters for each segment of the antenna may be different. For example, among other parameters, the frequency phase of the electrical current in each antenna segment and distance from each antenna segment to the space point Pₛ can be different.

A resonant frequency, f, of an antenna can have many different values as a function, for example, of dielectric constant of material surrounding antenna, the type of antenna and the speed of light.

In general, wave-length, λ, is given by λ=c/f=cT where c=velocity of light (=3×10⁸ meters/sec),f=frequency (cycles/sec), T=1/f=period (sec). Typically, the antenna dimensions such as antenna length, Aₗ, relate to the radiation wavelength λ of the antenna. The electrical impedance properties of an antenna are allocated between a radiation resistance, Rᵣ, and an ohmic resistance, Rₒ. The higher the ratio of the radiation resistance, Rᵣ, to the ohmic resistance, Rₒ the greater the radiation efficiency of the antenna.

Antennas are frequently analyzed with respect to the near field and the far field where the far field is at locations of space points P_{c} where the amplitude relationships of the fields approach a fixed relationship and the relative angular distribution of the field becomes independent of the distance from the antenna.

A number of different antenna types are well known and include, for example, loop antennas, small loop antennas, dipole antennas, stub antennas, conical antennas, helical antennas and spiral antennas. Such antenna types have often been based on simple geometric shapes. For example, antenna designs have been based on lines, planes, circles, triangles, squares, ellipses, rectangles, hemispheres and paraboloids. Small antennas, including loop antennas, often have the property that radiation resistance, Rᵣ, of the antenna decreases sharply when the antenna length is shortened. Small loops and short dipoles typically exhibit radiation patterns of ½λ and ¼λ , respectively. Ohmic losses due to the ohmic resistance, Rₒ, are minimized using impedance matching networks. Although impedance matched small loop antennas can exhibit 50% to 85% efficiencies, their bandwidths have been narrow, with very high Q, for example, Q>50. Q is often defined as (transmitted or received frequency)/(3 dB bandwidth).

An antenna goes into resonance where the impedance of the antenna, measured with a network analyzer, is purely resistive and the reactive component goes to 0. Impedance is a complex number consisting of real resistance and imaginary reactance components. A matching network forces a resonance by eliminating the reactive component of impedance for a particular frequency.

The cross-referenced application entitled ARRAYED-SEGMENT LOOP ANTENNA describes an arrayed-segment loop antenna formed of many segments connected in an electrical series where the segments are arrayed in multiple divergent directions that tend to increase the antenna electrical length while permitting the overall outside antenna dimensions to fit within the antenna areas of communication devices. The loop antenna operates in a communication device to exchange energy at a radiation frequency and includes a connection having first and second connection points for conduction of electrical current in a radiation loop. The radiation loop includes a plurality of electrically conducting segments each having a segment length. The segments are connected in series electrically between first and second connection points for exchange of energy at the radiation frequency. The loop has an electrical length, A, that is proportional to the sum of segment lengths for each of the radiation segments. The electrical length of the arrayed-segment loop antenna is typically equal to the radiation wavelength, λ, for the antenna or multiples or submultiples thereof including ½λ.

Antennas located internal to the housings of personal communicating devices tend to de-tune due to external objects, such as a human hand, placed in close proximity to the personal communicating devices. When such objects are in close proximity to the communicating devices, they are typically located in the near field of the antenna. In particular, conductive surfaces, components, shielding and other elements that are internal to communicating devices can cause parasitic interactions to antennas that are in close proximity.

In consideration of the above background, there is a need for improved antenna designs that achieve the objectives of physical compactness suitable for personal communication devices, that tend to be immune from interference by near field objects and that otherwise have acceptable antenna design parameters.

### SUMMARY

The present invention is a loop antenna formed of a radiation loop and a reference loop. The reference loop is generally the same size, shape and electrical length as the radiation loop and is located in the near field of and in close proximity to the radiation loop. In communication devices having conductive surfaces, components, shielding and other conductive elements in close proximity to the radiation loop that tend to de-tune or otherwise interfere with the operation of the radiation loop is reduced by the reference loop.

In one embodiment, the loop antenna is an arrayed-segment loop antenna having as one component a radiation loop formed of many segments connected in a electrical series where the segments are arrayed in multiple divergent directions that tend to increase the antenna electrical length while permitting the overall outside antenna dimensions to fit within the antenna areas of communication devices. The arrayed-segment loop antenna has as another component a reference loop formed of many segments connected in a electrical series where the segments are arrayed in multiple divergent directions which approximately match in size, number and layout the segments of the radiation loop. Typically, the radiation loop is mounted on one side of a substrate and the reference loop is mounted on the other side of the substrate. The substrate is any dielectric material and can be in rigid or flexible form.

The loop antenna operates in a communication device to exchange energy at a radiation frequency and the radiation loop includes first and second connection points for enabling conduction of electrical current through the radiation loop. The electrical current in the radiation loop is proportional to the emitted or received radiation. The radiation loop has an electrical length, A, that is proportional to the sum of the segment lengths for each of the radiation segments. The segments are arrayed in a pattern so that different segments connect at vertices and conduct electrical current in different directions near the vertices.

The arrayed segments that form the radiation loop and the reference loop may be straight or curved and of any lengths. Collectively the arrayed segments appreciable increase an antenna's electrical length while permitting the antenna to fit within the available area of a communicating device. The electrical length of the arrayed-segment loop antenna is typically equal to the radiation wavelength, λ, for the antenna or multiples or submultiples thereof including ½λ.

The antenna of the present invention in various embodiments,

mitigates de-tuning due to the effects of non-uniform grounding structures existing as a result of electronic elements (particularly electronic elements protruding above printed circuit boards), extrusions in metallic cases, fasteners, motors, shielding light-emitting diodes (LED's), wiring, interconnects, batteries or other conductive or semi-conductive elements near the antenna;

tempers de-tuning due to biologic tissues, such as hands, head or other body features, located in close proximity to the antenna;

reduces sensitivity to de-tuning as the antenna moves closer to one or multiple arbitrarily located ground planes other elements;

is applicable to any type of loop antenna and is readily implemented with good design efficiency for half-wave loop antennas;

can be placed close to one or more ground planes or other conducting elements while providing reliably and efficient operation that is suitable for cell phones, personal data assistants (PDA's), laptop computers and other communication devices;

can be constructed using thin substrates that also serve as, or are mounted like, a label, sticker or other adhesive attachment having printed indicia without being de-tuned by underlying conductive and dielectric structures;

can be flexible so as to conform to non-planar and/or movable surfaces or shapes without being de-tuned;

can be applied to the inner or outer surfaces of non-conductive housings or of semi-conductive surfaces with a minimal offset space;

can be part of or joined with an external product label having printed indicia reducing internal space requirements;

can be arrayed, nested, stacked or otherwise packaged in various configurations including one or more reference loops that increase the number of usable resonances, increase the bandwidth, and reduce the de-tuning, frequency shift and other unwanted effects of elements in close proximity to the antenna.

The foregoing and other objects, features and advantages of the invention will be apparent from the following detailed description in conjunction with the drawings.

### BRIEF DESCRIPTION OF THE DRAWINGS

FIG. 1 depicts a wireless communication unit, showing by broken line the location of an antenna area.

FIG. 2 depicts a schematic, cross-sectional end view of the FIG. 1 communication unit.

FIG. 3 depicts an isometric view of the antenna of FIG. 2.

FIG. 4 depicts across-sectional view of a segment along the section line 4′-4″ of FIG. 3.

FIG. 5 depicts atop view of around loop antenna layer connected to a transmission line matching element.

FIG. 6 depicts atop view of a round loop reference layer, to be juxtaposed the antenna layer of FIG. 5, connected to a termination pad.

FIG. 7 depicts an isometric view of a round loop antenna layer on a substrate connected to a transmission line matching element with a connection through the substrate.

FIG. 8 depicts an isometric view of a round loop antenna layer connected to a transmission line matching element on a flexible substrate where the substrate and connection element bend to a position offset from the antenna layer.

FIG. 9 depicts the components of the device of FIG. 1.

FIG. 10 depicts atop view of an irregular-shaped loop antenna layer on a substrate connected to a transmission line matching element.

FIG. 11 depicts a bottom view of an irregular-shaped reference layer on a substrate, to be juxtaposed the antenna layer of FIG. 10, connected to a termination pad.

FIG. 12 a front view of the irregular-shaped loop antenna layer of FIG. 10 on the same substrate as the irregular-shaped reference layer of FIG. 11.

FIG. 13 depicts VSWR waveforms with and without interference due to a human hand for the antenna of FIG. 10 without the reference loop of FIG. 12.

FIG. 14 depicts VSWR waveforms with and without interference due to a human hand for the antenna of FIG. 10 with the reference loop of FIG. 12.

FIG. 15 depicts a comparison of VSWR waveforms for the antenna of FIG. 10 with the reference loop of FIG. 12 and without the reference loop of FIG. 12.

FIG. 16 depicts an isometric view of an antenna including a radiation loop and two reference loops.

FIG. 17 depicts an end view of the multilayer antenna of FIG. 16.

FIG. 18 depicts a wireless communication unit in the form of a portable computer having spaced apart antennas connected by a transmission line to a circuit card internal to the computer.

FIG. 19 depicts another embodiment of the spaced-apart antennas of FIG. 18.

FIG. 20 depicts a top view of a portion of another embodiment of the spaced-apart antennas of FIG. 18.

FIG. 21 depicts a sectional view along section line 21′-21″ of the antenna of FIG. 20.

### DETAILED DESCRIPTION

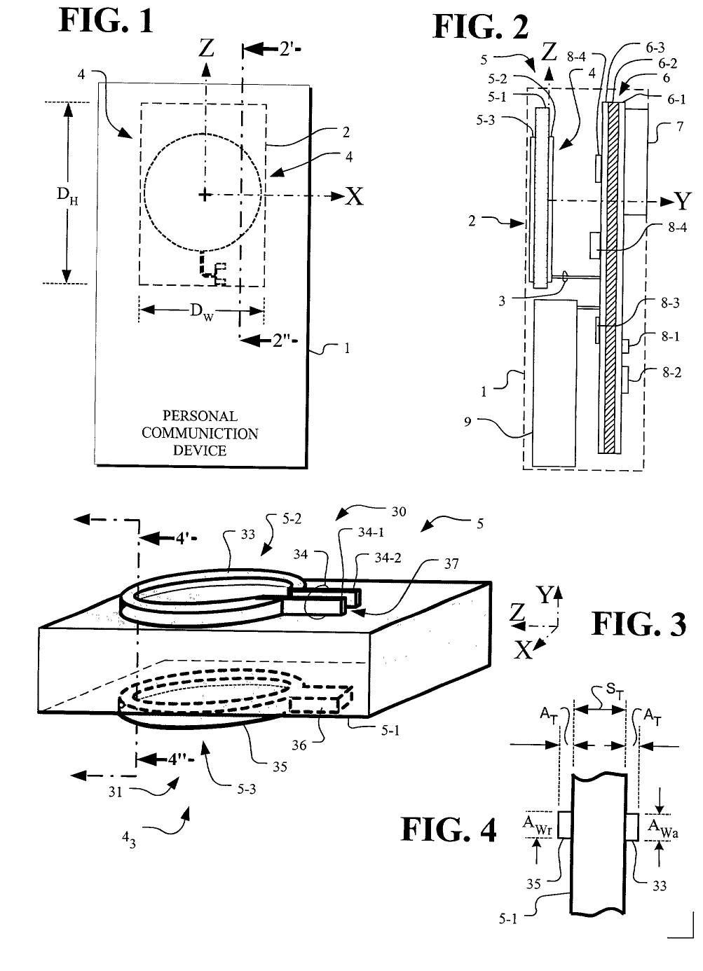

In FIG. 1, personal communication device 1 is a cell phone, pager, computer or other similar communication device that is used in close proximity to people. The communication device 1 includes an antenna area 2 for an antenna 4 which receives and/or transmits radio wave radiation from and to the personal communication device 1. In FIG. 1, the antenna area 2 has a width D_{W} and a height D_{H}. A section line 2′-2″ extends from top to bottom of the personal communication device 1.

In FIG. 2, the personal communication device 1 of FIG. 1 including antenna 4ₗ is shown in a schematic, cross-sectional, end view taken along the section line 2′-2″ of FIG. 1. In FIG. 2, a printed circuit board 6 includes, by way of example, one conducting layer 6-1, a dielectric layer 6-2 and another conducting layer 6-3. The printed circuit board 6 supports the electronic elements associated with the communication device 1 including a display 7 and miscellaneous electronic elements 8-1, 8-2, 8-3 and 8-4 which are shown as typical. The electronic elements 8 form a non-uniform grounding environment tending to cause de-tuning of the antenna 4. The electronic elements 8 include elements that function as a transmitter and receiver for the antenna 4. In an alternate embodiment, some or all of the elements 8 can be mounted on a flexible substrate, for example, the same substrate that supports the antenna 4.

Communication device 1 also includes a battery 9. The antenna assembly 5 includes a substrate 5-1, a conductive layer 5-2 on one side of the substrate and a conductive layer 5-3 on the other side of the substrate together with a connection element 3 to circuit board 6. Together, the substrate 5-1 and layers 5-2 and 5-3 form a loop antenna 4 in close proximity to and offset from the printed circuit board 6 by a gap which tends to suppress coupling between the antenna layer 5-2 and the printed circuit board 6. The conductive layer 5-2 and or the conductive layer 5-3 are connected to printed circuit board 6 typically by a coaxial conductor 3. The antenna of FIG. 1 and FIG. 2 is, in certain embodiments, an arrayed-segment loop antenna that has small area so as to fit within the antenna area 2 that has good performance in transmitting and receiving signals. The shape and size of the antenna area 2 can have many variations that are dependent on the shapes and sizes of communication devices, including their internal and external configurations.

In FIG. 3, the antenna assembly 5 includes the substrate 5-1, a conductive layer 5-2 and a conductive layer 5-3. Together, the substrate 5-1 and layers 5-2 and 5-3 form a loop antenna 4₃. The conductive layer 5-1 is formed into a radiation component 30 that includes loop 33 that terminates in connectors 34. The connectors 34 in some embodiments have transmission line characteristics. The loop 4₃ has an electrical length, Aₗ. The conductive layer 5-2 is formed into a reference component 31 that includes a loop 35 that terminates in a connector 36 in the form of a pad. The loop 33 and connector 34 in the radiation component 30 are positioned directly over and in vertical alignment (Y axis) with the loop 35 and connector 36 of the reference component 31 as separated by the substrate 5-1. In the embodiment shown, loop 35 and loop 36 have approximately the same radius and other dimensions and have the same vertical alignment (Y axis) on opposite faces of substrate 5-1. The connectors 35 and 36 have approximately the same outside dimensions and have the same vertical alignment on opposite faces of substrate 5-1. However, the connectors 35 are not electrically connected and are separate by an opening 37 while the connector 36 is a continuous element (pad). In FIG. 3, the connector 34 is a connection means formed of first and second conductors 34-1 and 34-2 for non-radiating conduction of electrical current between the circuit board 6 of FIG. 2 and the radiation loop 33 of antenna 4₃.

The antenna assembly 5 including the substrate 5-1, conductive layer 5-2 and conductive layer 5-3 maybe formed by printing, screening or conventional steps using conventional materials. In some embodiments, the antenna assembly is affixed to the enclosure of a communication device using printing, screen or other conventional steps or by adhesively attaching an otherwise completed antenna assemble to the enclosure.

While the antenna 4₃ of the FIG. 3 embodiment is circular, many variations are possible including the segmented loop antennas described in the above-identified cross-referenced application. Regardless of the particular shape of the antenna, the antenna includes a radiation loop, such as loop 33, and a reference loop, such as loop 35 separated by an dielectric layer, such as substrate 5-1. The connectors 34 and 36 can have many variations. For example, the connectors 34 can be spaced apart leads, such as leads 34-1 and 34-2, can be a connection pad and can be part of a single layer transmission line or multiple layer transmission line together with the pad connector 36 or other element. The connector 36 can be a single electrical element, such as shown in FIG. 3, can be a pair of leads, can be part of a multiple layer transmission line together with the leads 34-1 and 34-2 or can be some other element. The pad 36 and loop 35 can be floating electrically without any direct electrical connection or may be connected in an electrical circuit, for example, at a ground plane or other location of the circuit board 6 of FIG. 2.

In FIG. 4, a schematic sectional view along the section line 4′-4″ of FIG. 7 is shown. In the example of FIG. 4, the thickness, S_{T}, of the dielectric substrate 5-1 is approximately 0.08 mm. The width, A_{Wr}, of the segment 33 is approximately 1.8 mm and the thickness, A_{T}, of the segment 33 is approximately 1.8 mm. The width, A_{Wa}, of the segment 35 is approximately 1.8 mm and the thickness, A_{T}, of the segment 35 is approximately 0.02 mm.

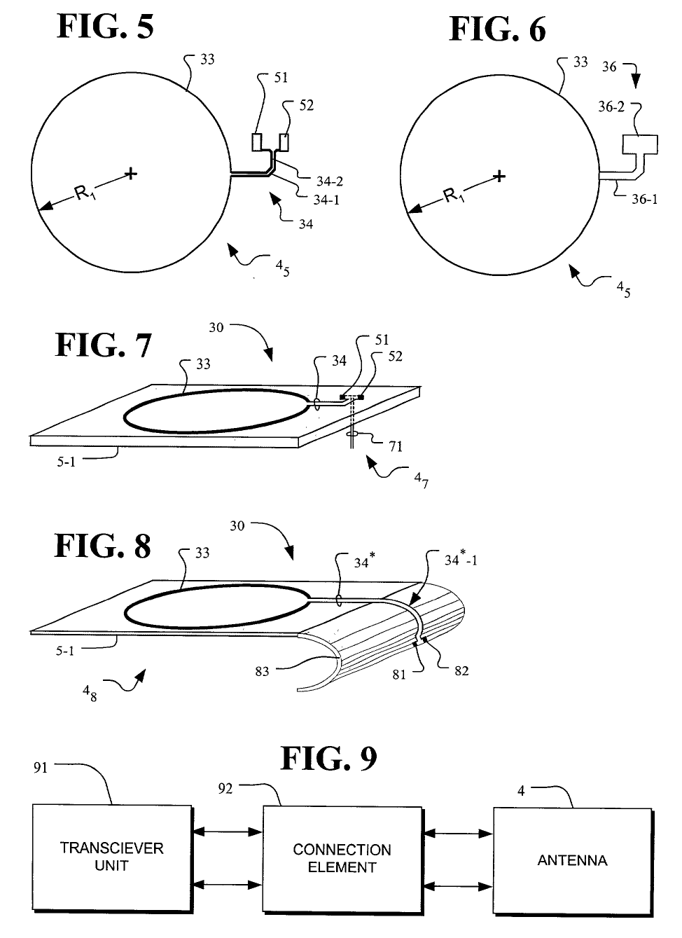

FIG. 5 depicts atop view of a portion of around loop antenna 4₅ having an radiation loop 33 with a length of about 150 mm for full wave operation (about 75 mm for half-wave operation) and having a transmission line matching element 34 that terminates in connection pads 51 and 52. The antenna 45 is designed for a frequency of approximately 1900 MHz and has a physical length of approximately 150 mm for full wave operation (approximately 75 mm for half-wave operation). The antenna 4₅ of FIG. 5 is, therefore, designed for operation at about the center of the US PCS band.

In FIG. 5, the loop antenna 4₅ has a radius, Rₗ, for full wave operation that equals about 150/πmm (for half wave operation Rₗ equals about 75/πmm). The matching element 34 is not necessarily drawn to scale for matching the radiation loop 33 to an impedance of 50 ohms, the typical output impedance of the electrical circuit 6 of FIG. 2.

FIG. 6 depicts a bottom view portion of the round loop antenna 4, of FIG. 5 having a reference loop 35 with a length of about 150 mm for full wave operation (approximately 75 mm for half wave operation) and having a connector element 36 having a line portion 36-1 that terminates in a pad 36-2.

In FIG. 7, a top view of a portion of around loop antenna 47 of FIG. 5 has an radiation loop 33 and a transmission line matching element 34 that terminates in connection pads 51 and 52. In FIG. 7, a through-layer connector 7l connects through layer 5-1 to connect at one end to pads 51 and 52 and the other end is designed for connection to the electrical circuit 6 of FIG. 2.

In FIG. 8, a top view of a portion of a round loop antenna 48 like that of FIG. 5 has an radiation loop 33 and a transmission line matching element 34 that terminates in connection pads 81 and 82. In FIG. 8, base layer 5-1 is made of a flexible material that is readily bent with a curved section 83 that supports the connector 34* with a curved section 34*-1 connecting to connection pads 81 and 82. The connection pads 81 and 82 are designed to connect to the electrical circuit 6 of FIG. 2. The section 83 is flexible so that pads 81 and 82 can be moved easily to connect to circuit board 6 of FIG. 2 without need for any particular angle or critical offset distance.

FIG. 9 depicts the components that form the device of FIG. 1. In particular, the transceiver unit 91 is formed by one or more of the components 8 mounted on the circuit board 6 of FIG. 2. The connection element 92 connects the transceiver unit 91 to the antenna 4. Byway of example, the matching element 92 corresponds to the transmission line 34 and pad connectors 51 and 52 of FIG. 5 and the connector 36 of FIG. 6.

Formulas for determining the impedance, Z_{TL}, of printed transmission lines are based upon many parameters which in some embodiments are described in the above-identified cross-referenced application entitled ARRAYED-SEGMENT LOOP ANTENNA.

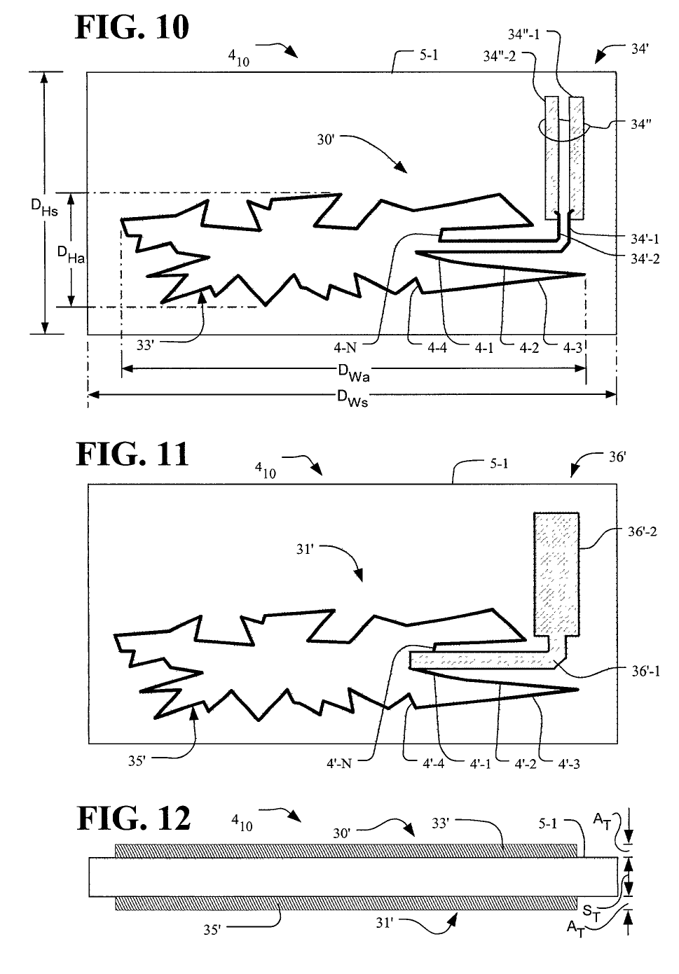

In FIG. 10, a radiation loop 33′ part of an irregular-shaped arrayed-segment loop antenna 4₁₀ is shown. The radiation loop 33′ includes an array of line segments 4-1, 4-2, 4-3, 4-4, . . . , 4-N connected in electrical series. The segments of the radiation loop 33′ are straight line and are arrayed without any particular symmetry. The radiation loop 33′ part of loop antenna 4₁₀, includes a coplanar connector 34′. The coplanar connector 34′ includes the electrically connected leads 34′-1 and 34″-1 and the electrically connected leads 34′-2 and 34″-2. The electrical length, Aₗ₋₁₀ of loop antenna 4₁₀ is approximately 165 mm and measures approximately D_{Ha}=10 mm and D_{Wa}=26 mm. The antenna substrate measures approximately D_{H}=50 mm and D_{Ws} ,=65 mm and fits within the area 2 of FIG. 1.

In one embodiment, the irregular-shaped loop antenna 4₁₀ of FIG. 10 has a reference loop 33′ of about 165 mm and includes a matching element 34′. The reference loop 33′ of antenna 4,₀ produces an antenna which has a resonance of approximately 850 MHz which is near the center of the US Cellular band.

In FIG. 11, a reference loop 35′ part of the irregular-shaped arrayed-segment loop antenna 4₁₀ is shown. The reference loop 35′ includes an array of line segments 4′-1, 4′-2, 4′-3, 4′-4, . . . , 4′-N connected in electrical series. The segments of the reference loop 35′ are straight line and are arrayed without any particular symmetry. The segments of the reference loop 35′ generally match the shape, size and layout of the segments of radiation loop 33′. The reference loop part of loop antenna 4 includes a connector 36′ that includes connector 36′-1 and pad 36′-2. The connector 36′-1 has a size, shape and layout that matches the outside projection of the connectors 34′-1 and 34′-2 of FIG. 10. The connector 36′-2 has a size, shape and layout that matches the outside projection of the connectors 34″-1 and 34″-2 of FIG. 10.

The antennas 4 of the present specification are designed to operate with the standard frequency bands over the small communication device spectrum from 400 MHz to 6000 MHz and over other spectrums.

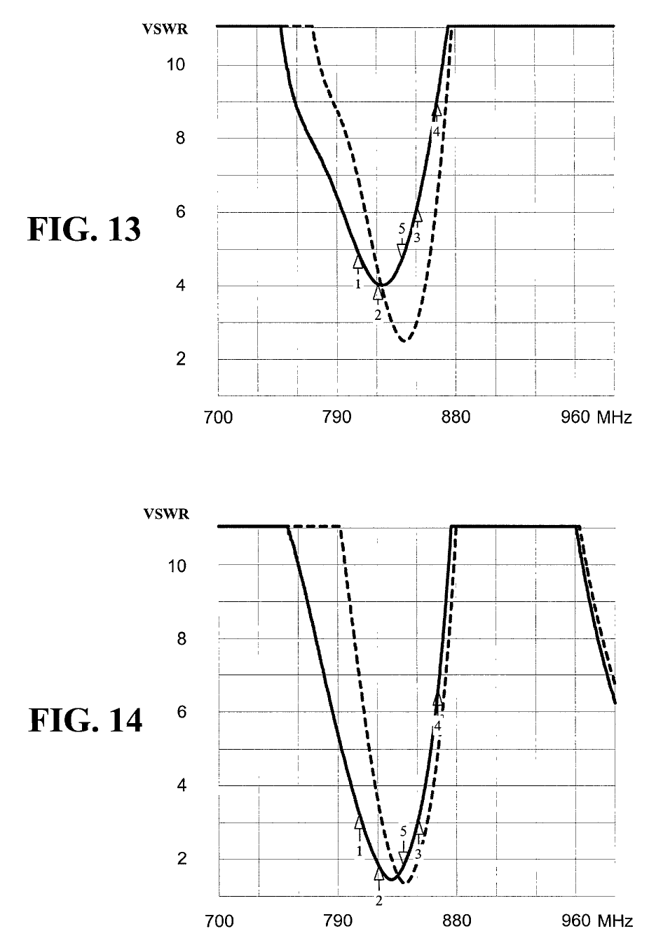

FIG. 13 depicts VSWR waveforms with and without the near field interference, such as caused by the proximity of a human hand, for the antenna of FIG. 10 without the reference loop of FIG. 12.

FIG. 14 depicts VSWR waveforms with and without interference, such as caused by the proximity of a human hand, for the antenna of FIG. 10 with the reference loop of FIG. 12.

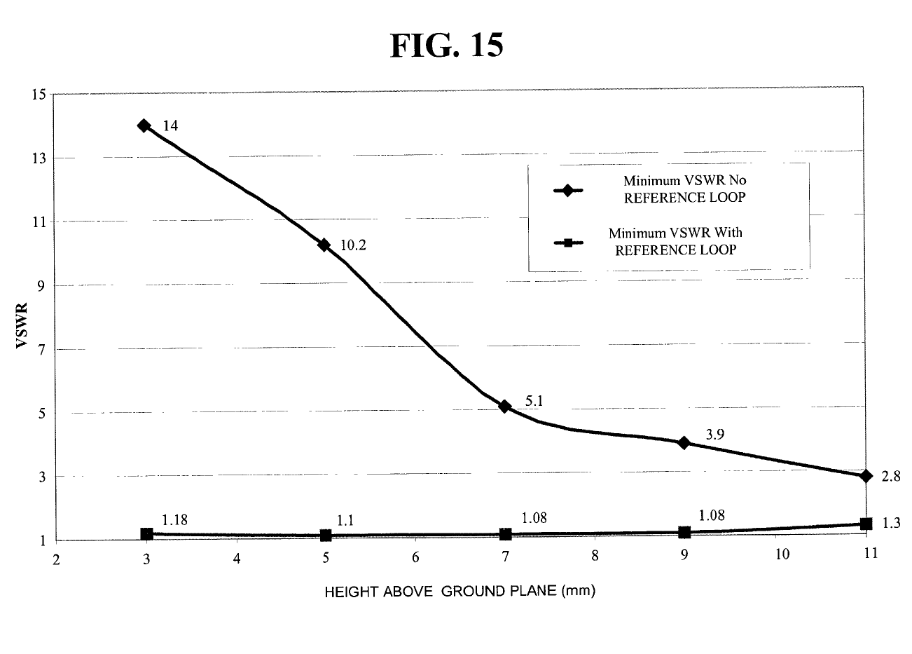

FIG. 15 depicts a comparison of VSWR waveforms for the antenna of FIG. 10 where one trace is with the reference loop of FIG. 12 and where the other trace is without the reference loop of FIG. 12.

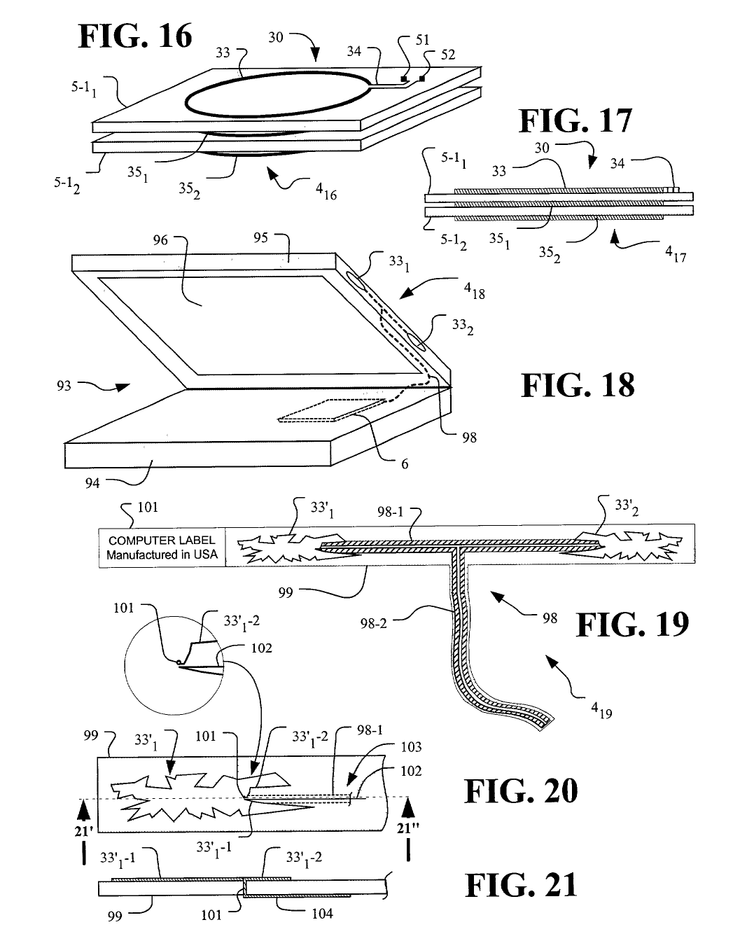

In FIG. 16, the antenna 4₁₆ includes dielectric substrates 5-1₁ and 5-1₂ and a radiation component 30 that includes loop 33 that terminates in connector 34. The connector 34 in some embodiments has transmission line characteristics. The antenna 4₁₆ also has a reference component that includes loops 35₁ and 35₂ which each are, for example, like the reference loop 35 in FIG. 3 that terminate in pads (not shown in FIG. 16). The radiation loop 33 is positioned directly over and in vertical alignment (Y axis) with the reference loops 35₁ and 35₂. In the embodiment of FIG. 16, loops 35₁ and 35₂ have approximately the same radius and other dimensions and have the same vertical alignment (Y axis) as radiation loop 33. In the FIG. 16 embodiment, the use of multiple reference layers including loops 35₁ and 35₂ increases the isolation of the radiation loop 33 from unwanted coupling to conductive elements in close proximity thereto.

In FIG. 17, the antenna 4₁₆ includes dielectric substrates 5-11 and 5-12, radiation component 30 includes a loop 33 that terminates in connector 34, and includes reference loops 35₁ and 35₂ on either side of substrate 5-1₂. The radiation loop 33 is positioned directly over and in vertical alignment with the reference loops 35₁ and 35₂

FIG. 18 depicts a wireless communication unit in the form of a portable computer 93 having a base 94 and a hinged cover 95 carrying a display 96. The loop antennas 33₁ and 33₂ are spaced apart and connected by transmission line 98 to a circuit card 6 internal to the base 94 of the computer 93. The transmission line 98 is flexible and therefore is able to bend with the opening and closing of cover 96 about the hinge with the base 94.

In FIG. 19, the antenna 4₁₉ includes a pair of loop antennas 33′₁ and 33′₂ that are spaced apart and connected by transmission line 98 to a circuit card 6, for example, as shown internal to the base 94 of the computer 93 of FIG. 18. The transmission line 98 includes a straight portion 98-1 connecting between antennas 33′₁ and 33′₂ on a common dielectric substrate 99. The transmission line 98 is flexible and therefore the tail portion 98-2 is able to bend with the opening and closing, in FIG. 18, of cover 96 about the hinge with the base 94. The antenna 4₁₉ is also formed integral with a label portion 101 and has an adhesive backing for adhering to the side of the cover 95 in FIG. 18. While the label portion 101 is shown offset to the side of antenna 33′₂, the label or printed indicia can be superimposed over any part or all of the antenna 4₁₉.

In FIG. 20, a top view of a portion of another embodiment of the spaced-apart antennas of FIG. 18. FIG. 20 shows an antenna loop 33′₁ like loop 33′₁ in FIG. 19. In FIG. 20, the radiation loop top portion 33′₁-l of antenna loop 33′₁ connects through a through-layer via connection 101 to a strip-line conductor 104 of transmission line 103 on the bottom surface of the substrate 99. The radiation loop bottom portion 33′₁-2 of antenna loop 33′₁ connects to a trace line 102 portion of the strip-line transmission line 103 that appears on the top surface of substrate 99 centered over the strip-line conductor 104.

FIG. 21 depicts a sectional view along section line 21′--21″ of the antenna portion of FIG. 20.

While the invention has been particularly shown and described with reference to preferred embodiments thereof it will be understood by those skilled in the art that various changes in form and details may be made therein without departing from the scope of the invention.

1. (Original) A loop antenna, for use with a communication device, operating for exchanging energy at a radiation frequency, comprising,
a radiation component including,
connection means having first and second electrical connection points for conduction of electrical current,
a radiation loop arrayed for radiation and connected to said connection means for conducting said electrical current through said radiation loop in connection with said radiation,
a reference component including,
a reference loop having approximately the same size and shape as said radiation loop and arrayed offset from and in close proximity to said radiation loop.

2. (Original) The loop antenna of claim 1 wherein said radiation loop includes a plurality of electrically conducting segments each having a segment length where,
said segments are electrically connected in series between said first and second connection points for exchange of energy at the radiation frequency, said radiation loop having an electrical length, Aₗ that is proportional to the sum of segment lengths for each of said radiation segments,
said segments are arrayed in a pattern so that different segments connect at vertices and conduct electrical current in different directions near said vertices.

3. (Original) The loop antenna of claim 1 wherein said connection means is a transmission line for non-radiation conduction.

4. (Original) The loop antenna of claim 1 wherein said radiation component and said reference component are mounted on opposite sides of a dielectric substrate.

5. (Original) The loop antenna of claim 4 wherein said dielectric substrate is flexible whereby said loop antenna is a curved surface.

6. (Original) The loop antenna of claim 4 wherein said dielectric substrate is flexible whereby said loop antenna conforms to a curved surface of the communication device.

7. (Original) The loop antenna of claim 1 wherein said radiation frequency has a radiation wavelength, λ, and said radiation component has an electrical length of ½λ.

8. (Original) The loop antenna of claim 1 wherein said radiation frequency has a radiation wavelength, λ, and said radiation component has an electrical length of multiples or submultiples of λ.

9. (Original) The loop antenna of claim 1 wherein said segments are arrayed in multiple divergent directions that tend to increase the loop antenna electrical length while permitting the overall outside dimensions of said loop antenna to fit within an antenna area of said communication device.

10. (Original) The loop antenna of claim 1 wherein said connection means includes contact areas for coupling to a transceiver of said communication device.

11. (Original) The loop antenna of claim 1 wherein said radiation loop has one impedance value and said transmission line has a compensating impedance value whereby the combined impedance value of the loop antenna equals a predetermined impedance value.

12. (Original) The loop antenna of claim 1 wherein said radiation loop has a loop impedance value equal to a predetermined impedance value.

13. (Original) The loop antenna of claim 12 wherein said predetermined impedance value is 50 ohms.

14. (Original) The loop antenna of claim 1 wherein said radiation loop has an irregular shape wherein said segments are arrayed with no particular regular pattern.

15. (Original) The loop antenna of claim 1 wherein said segments include straight and curved segments.

16. (Original) The loop antenna of claim 1 wherein said segments are formed of a conductor on a flexible dielectric substrate.

17. (Original) The loop antenna of claim 1 wherein said connection means is a transmission line for non-radiation conduction and wherein said segments and said transmission line are formed of conductors on a common dielectric material.

18. (Original) The loop antenna of claim 1 wherein said radiation loop transmits and receives radiation.

19. (Original) The loop antenna of claim 18 wherein said radiation loop transmits and receives radiation in the US PCS band.

20. (Original) The loop antenna of claim 18 wherein said radiation loop transmits and receives radiation in the US Cellular band.

21. (Original) The loop antenna of claim 2 wherein said radiation loop transmits and receives radiation in the small communication device spectrum.

22. (Original) A loop antenna, for use with a communication device, operating for exchanging energy at one or more radiation frequencies, comprising,
connection means for coupling of electrical current,
a plurality of radiation components each including one of a plurality of radiation loops, each of said radiation loops arrayed for radiation at one or more of said radiation frequices and connected to said connection means for conducting said electrical current in connection with said radiation,
a plurality of reference components, one for each of said radiation components, each reference component including a reference loop having approximately the same size and shape as a corresponding one of said radiation loops and arrayed offset from and in close proximity it to said corresponding one of said radiation loops.

23. (Original) The loop antenna of claim 22 wherein one or more of said radiation loops includes a plurality of electrically conducting segments each having a segment length where,
said segments are electrically connected in series between said first and second connection points for exchange of energy at the radiation frequency, said radiation loop having an electrical length, Aₗ that is proportional to the sum of segment lengths for each of said radiation segments,
said segments are arrayed in a pattern so that different segments connect at vertices and conduct electrical current in different directions near said vertices.

24. (Original) The loop antenna of claim 22 wherein said connection means is a transmission line for non-radiation conduction.

25. (Original) The loop antenna of claim 22 wherein one or more of said radiation components and a corresponding one or more of said reference components are mounted on opposite sides of one or more dielectric substrates.

26. (Original) The loop antenna of claim 25 wherein one or more of said dielectric substrates is flexible whereby one or more of said loop antennas forms a curved surface.

27. (Original) The loop antenna of claim 25 wherein one or more of said dielectric substrates is flexible whereby one or more of said loop antennas conforms to a curved surface of the communication device.

28. (Original) The loop antenna of claim 22 wherein one or more of said radiation frequencies has a radiation wavelength, λ.

29. (Original) The loop antenna of claim 22 wherein one or more of said radiation frequencies has a radiation wavelength, λ, and one or more of said radiation components has an electrical length of multiples or submultiples of λ.

30. (Original) The loop antenna of claim 22 wherein said connection means includes contact areas for coupling to a transceiver of said communication device.

31. (Original) The loop antenna of claim 22 wherein one or more of said radiation loops has one impedance value and said transmission line has a compensating impedance value whereby the combined impedance value of the one or more of said radiation loops equals a predetermined impedance value.

32. (Original) The loop antenna of claim 31 wherein said predetermined impedance value is 50 ohms.

33. (Original) The loop antenna of claim 22 wherein one or more of said radiation loops has an irregular shape with segments arrayed with no particular regular pattern.

34. (Original) A communication device for communication at a radiation frequency, comprising:
an electrical circuit board including electronic elements,
a loop antenna connected to said circuit board and operating for exchanging energy at radiation
frequency, said loop antenna including,
a radiation component including,
connection means having first and second electrical connection points for conduction of electrical current,
a radiation loop arrayed for radiation and connected to said connection means for conducting said electrical current through said radiation loop in connection with said radiation,
a reference component including,
a first reference loop having approximately the same size and shape as said radiation loop and arrayed offset from and in close proximity to said radiation loop.

35. (Original) The communication device of claim 34 wherein said electronic elements form a non-uniform grounding environment tending to cause de-tuning of said radiation loop and said reference component is disposed in close proximity to said radiation component to mitigate against said de-tuning.

36. (Original) The communication device of claim 34 located from time to time in proximity to a human body feature tending to cause de-tuning of said radiation loop where said reference component is disposed in close proximity to said radiation component to mitigate against said de-tuning.

37. (Original) The communication device of claim 34 wherein said connection means is a transmission line for non-radiation conduction.

38. (Original) The communication device of claim 34 wherein said radiation component and said reference component are mounted on opposite sides of a dielectric substrate.

39. (Original) The communication device of claim 38 wherein said dielectric substrate is flexible.

40. (Original) The communication device of claim 38 wherein said dielectric substrate is flexible and conforms to a curved surface of the communication device.

41. (Original) The communication device of claim 34 wherein said radiation frequency has a radiation wavelength, λ, and said radiation component has an electrical length of ½λ.

42. (Original) The communication device of claim 34 wherein said radiation frequency has a radiation wavelength, λ, and said radiation component has an electrical length of multiples or submultiples of λ.

43. (Original) The communication device of claim 34 wherein said segments are arrayed in multiple divergent directions that tend to increase the loop antenna electrical length while permitting the overall outside dimensions of said loop antenna to fit within an antenna area of said communication device.

44. (Original) The communication device of claim 34 wherein said connection means includes contact areas for coupling to a transceiver of said communication device.

45. (Original) The communication device of claim 34 wherein said radiation loop has one impedance value and said transmission line has a compensating impedance value whereby the combined impedance value of the loop antenna equals a predetermined impedance value.

46. (Original) The communication device of claim 34 wherein said radiation loop has a loop impedance value equal to a predetermined impedance value.

47. (Original) The communication device of claim 46 wherein said predetermined impedance value is 50 ohms.

48. (Original) The communication device of claim 34 wherein said radiation loop has an irregular shape wherein said segments are arrayed with no particular regular pattern.

49. (Original) The communication device of claim 34 wherein said segments include straight and curved segments.

50. (Original) The communication device of claim 34 wherein said segments are formed of a conductor on a flexible dielectric substrate.

51. (Original) The communication device of claim 34 wherein said connection means is a transmission line for non-radiation conduction and wherein said segments and said transmission line are formed of conductors on a flexible dielectric substrate.

52. (Original) The communication device of claim 34 wherein said radiation loop transmits and receives radiation.

53. (Original) The communication device of claim 52 wherein said radiation loop transmits and receives radiation in the US PCS band.

54. (Original) The communication device of claim 52 wherein said radiation loop transmits and receives radiation in the US Cellular band.

55. (Original) The communication device of claim 52 wherein said radiation loop transmits and receives radiation in the small communication device spectrum.

56. (Original) The communication device of claim 34 wherein said loop antenna is constructed of thin, flexible dielectric and conductive layers.

57. (Original) The communication device of claim 56 wherein said loop antenna includes an adhesive for mounting said loop antenna on a surface of said communication device.

58. (Original) The communication device of claim 57 wherein said surface is internal to said communication device.

59. (Original) The communication device of claim 57 wherein said surface is external to said communication device.

60. (Original) The communication device of claim 57 wherein said loop antenna is part of a label having printed indicia for said communication device.

61. (Original) The communication device of claim 34 wherein said loop antenna is mounted on part of said communication device movable relative to said electrical circuit board.

62. (Original) The communication device of claim 34 formed as a portable computer wherein said loop antenna is mounted on a housing for a display movable relative to a base housing said electrical circuit board.

63. (Original) The communication device of claim 34 wherein said loop antenna is formed of one or more radiation loops and one or more reference loops arrayed to form a plurality of resonance frequencies, having a combined bandwidth greater than a bandwidth for a single resonance frequency, tending to be immune to de-tuning or frequency shift as a result of elements in close proximity to the radiation loops.

64. (Original) A communication device for communication at a radiation frequency with a radiation wavelength, λ, comprising:
an electrical circuit board including transmitter and receiver electronic elements,
a loop antenna connected to said circuit board and operating for exchanging energy at said radiation frequency, said loop antenna including,
a flexible dielectric layer,
a flexible radiation component formed on one side of said dielectric layer including, connection means having first and second electrical connection points for conduction of electrical current, said connection means including a transmission line for non-radiation conduction,
a radiation loop having a plurality of electrically conducting segments arrayed in an irregular pattern for radiation with an approximate electrical length equal to a multiple of ½λ and connected to said connection means for conducting said electrical current through said radiation loop in connection with said radiation,
a flexible reference component formed on another side of said dielectric layer including,
a first reference loop having a plurality of electrically conducting segments arrayed in an irregular pattern of approximately the same size and shape as said radiation loop and arrayed offset from and in close proximity to said radiation loop.
